(19) United States
(12) Patent Application Publication
(10) Pub. No.: US 2009/0145516 A1
(43) Pub. Date: Jun. 11, 2009

(54) Device for Preventing Full Introduction of a First Conduit into a Second Conduit

(76) Inventors: Mark Wells, Rutland (GB); Anthony Joy, Warwick (GB)

Correspondence Address: GREENLEE WINNER AND SULLIVAN P C, 4875 PEARL EAST CIRCLE, SUITE 200, BOULDER, CO, 80301, US

(21) Appl. No.: 12/278,689

(22) PCT Filed: Feb. 9, 2007
(86) PCT No.: PCT/GB2007/000450

§ 371 Date: Dec. 1, 2008

(30) Foreign Application Priority Data
Feb. 9, 2006 (GB) 0602645.4
Aug. 9, 2006 (GB) 0615825.7

(51) Int. Cl. B60K 15/04; B65B 1/04

(52) U.S. Cl. 141/367; 220/86.2

(57) ABSTRACT

A device for preventing the introduction of a first conduit into a second conduit includes an insert (3) to be mounted to the second conduit (1). The insert (3) includes a blocking portion (6) sized to block entry of the first conduit (2) into the second conduit (1). The insert (3) is mounted to the second conduit (1) so as not to interfere with flow of a substance from a third conduit (4) into the second conduit (1). The insert (3) may be retractable and biased towards a position where the blocking portion (6) extends from the second conduit (1). A substance deflector (12) may be provided to impede flow of a substance from the first conduit (2) into the second conduit (1). The insert (3) may have many applications, but is particularly suited to use in the fuel inlet port of the neck of a diesel fuel tank to prevent unintended introduction of unleaded petrol.

This application relates to a device for preventing the introduction of a first conduit into a second conduit, and in particular to the introduction of a petrol delivery nozzle into the neck of a diesel tank.

It has been appreciated for some time that the advent of diesel vehicles into the domestic market made it very easy and common for diesel fuel to be wrongly selected at the pump and used to fill a petrol car. This results in the car being disabled until the carburetor or petrol injectors can be cleaned and the system flushed through.

To solve this problem, the necks of the petrol tank on petrol cars were reduced in diameter relative to those of diesel cars, and the pump nozzles varied accordingly. Hence, a diesel pump nozzle is larger in diameter than that of a petrol pump and will not fit into the neck of a modern petrol-driven car. This prevents a user filling a petrol car with diesel.

Traditionally, the concern was prevention of filling petrol cars with diesel or of filling unleaded petrol vehicles (with catalytic converters) with leaded fuel (as leaded fuel can damage catalytic converters). Little consideration has been given to preventing the filling of diesel cars with petrol. This is possible because the petrol nozzle is of a smaller diameter than that of the neck of a diesel tank (as discussed above). The rationale for this was logical, because the early diesel systems were very tolerant of burning some percentage of other fuels. This is no longer the case, and filling a diesel car with petrol-based fuel can now cost from £80 to £3,000 to rectify, particularly if the engine is started. Some vehicles may cost £8,000 to repair. It is thus now far more damaging to a vehicle to put petrol in the diesel tank than was previously the case.

It would be desirable to provide a device that will prevent all but the determined mis-fueler from putting unleaded petrol into the tank of a diesel car or light commercial vehicle.

The problem of mis-fuelling is a growing one. With the advent of the modern diesel engines mistakes are growing more costly and time inefficient. Combine this with the growth in multi-car, multi-fuel households and there is a growing recipe for disaster.

There have been several attempts to address this issue.

Audible warning systems (such as the Diesel Guard™ and Diesel Alert systems) provide an audible warning to the driver. The Diesel Guard™ system provides an external audible bleep and warning message reminding a driver correctly to fill his car. It is fitted inside the filler cap with the use of adhesive pads. The Diesel Alert system is hard wired with a 90 db speaker and is audible both in and out of the car. It comes with key fob and dashboard flashes. It is designed to remind a driver to check the fuel being used. A problem with these systems is that a reminder may not be presented to the user. These systems rely on the user listening to message and responding to it before they fill the tank.

The Diesel Director filling nozzle has an oval cross-section. Standard diesel filling nozzles at the forecourt are replaced by the Diesel Director nozzle and used with an oval filling aperture on the vehicle. A problem with this system is that take up by the petrol companies is required. Infrastructural investment is required both in terms of garage forecourts and in terms of the process of getting motor manufacturers to install a modified filler neck.

The MagnaCap system involves fitting a magnetic disc to the underside of the filler cap, with a similar, reverse polarity, disc fixed to the fuel pump adjacent to the diesel filler nozzle. The idea is that the motorist can remove the cap and fix it to the pump, if it falls off he is using the wrong pump. A problem with this system is that it relies on the driver responding to the warning. It also requires alteration of petrol forecourt infrastructure.

The Easy Fuel refuelling system consists of a sealed filler pipe insert and a fuel nozzle locator that guides the nozzle to the tank opening. The insert has an automatic diameter detector that only allows the larger diesel nozzle to be inserted into the filler pipe. It has mechanical lock out depending on the size of the nozzle that is being offered and either opens up the aperture or not depending on that information. This system is highly complex in its mode of operation and requires many moving parts.

GB 2 391 544 discloses a filler neck for a fuel tank. The filler neck has a blocking member positioned substantially below the mouth of the filler neck well into a vehicle fuel tank neck. In use the blocking member is designed to prevent a fuel filling nozzle being inserted in the filler neck except where the filling nozzle has an internal bore size sufficient to allow it to pass over the blocking member. A filler neck so arranged can be adapted to prevent the insertion of an unleaded petrol filling nozzle into the diesel filler neck because the internal bore of a diesel filling nozzle is larger than either the internal bore of an unleaded filling nozzle or a lead replacement petrol filling nozzle. The filler neck aims to provide a physical inhibition to insertion of a petrol filling nozzle thereby limiting the potential for filling the diesel fuel tank with petrol. A spring-like flexible rod may be provided to support the blocking member, and the blocking member may be in the form of a tubular truncated cone. The rod may be a coil bound spring, and a locating member may be provided to secure the rod in the filler neck. The blocking member may have spaced arms having an envelope in the form of a truncated cone.

US 2005/0000592 and U.S. Pat. No. 6,966,349 disclose a device located in a diesel fuel filler neck for preventing entry of an unleaded petrol nozzle.

Whilst existing systems that incorporate a blocking member may be simple, the known systems suffer from several drawbacks.

A blocking member would need to be positioned well into the fuel filler neck to enable a fuel cap to be installed. Such a blocking member is unable to act as a visible reminder to the user making it difficult to align the nozzle.

Known systems incorporating blocking members cause turbulence, increased back pressure and the flow to be reflected. This, in turn, causes the sensor in the fuel nozzle to be activated thereby stopping fuel flow. Therefore, such systems do not work well in practice.

Fixing mechanisms for blocking members may rely on the geometry of the fuel filler neck, which may vary per vehicle type. The devices may require a straight fuel filler neck. Blocking members could damage the vent pipe of a filling nozzle.

It may not be possible to fit the blocking member retrospectively to vehicles. Methods of fixing may be elaborate/potentially dangerous.

According to an aspect of the present invention, there is provided an insert for a receiving conduit for blocking full introduction of a first conduit having a first size into the receiving conduit, wherein the receiving conduit has a reception aperture of a second size, wherein the first size is smaller than the second size, the insert comprising mounting means for mounting the insert to the receiving conduit, wherein, when mounted to the receiving conduit, the insert physically blocks full introduction of the first conduit into the receiving conduit, but allows introduction of a third conduit having a third size into the receiving conduit, wherein the third size is smaller than the second size and is different from the first size.

The third size may be smaller than the first size. In the preferred embodiment, the third size is greater than the first size.

This arrangement provides a simple and effective way of preventing insertion of a first conduit into a receiving conduit having a larger size, whilst allowing insertion of a third conduit that is larger than the first conduit into the receiving conduit. This arrangement can be useful in circumstances where, for example, the third conduit is used to transfer a substance to the receiving conduit, but where the first conduit could accidentally be used to transfer an undesirable substance to the receiving conduit. Physically blocking full insertion of the first conduit alerts the user to the fact that an incorrect conduit has been selected.

In the preferred embodiment, the insert allows introduction of a fourth conduit having a fourth size, wherein the fourth size is smaller than the first size. With this arrangement, the insert allows introduction of a desirable conduit that is of a smaller size than the insert itself. This arrangement could be useful where desirable conduits may have different sizes.

The insert preferably comprises a blocking region, for blocking full introduction of the first conduit into the receiving conduit, and an access region, for facilitating flow of a substance from the third conduit through or around the receiving conduit. The presence of an access region allows a desired substance from the third conduit to flow more freely into the receiving conduit.

The insert may have an aperture through which a substance from the third conduit can flow. Depending on the overall shape of the insert, an aperture may facilitate flow of the desired substance from third conduit into receiving conduit.

The insert is preferably substantially cylindrical. This can provide a clean fit between the third conduit and the receiving conduit, especially where the conduits are also substantially cylindrical. Jamming of the conduit and insert is thus more likely to be avoided.

In the preferred embodiment, the insert, in cross-section, is the same shape and size as the first conduit. This is an efficient design enabling blocking of the first conduit whilst allowing third conduit to pass over the insert.

In an embodiment, the insert is a hollow tube. This helps to maximise the flow of a desired substance from the third conduit.

In the preferred embodiment, the insert includes a substance deflector for reducing a flow of a substance from the first conduit into the receiving conduit. This provides an additional mechanism for reducing the likelihood of a substance from the first conduit significantly entering the receiving conduit where the user is determined to ignore physical blocking of the first conduit.

Preferably the substance deflector substantially surrounds the insert. The combination of the blocking region and the substance deflector helps to avoid entry of the substance from the first conduit into the receiving conduit.

Preferably the substance deflector is offset longitudinally from the blocking region of the insert, in a direction away from the reception aperture. In this way, only a conduit that is not blocked by the blocking region of the insert can reach the substance deflector.

In an embodiment the substance deflector is movable to allow access therebeyond by the third conduit, introduction of which is allowed by the insert.

In the preferred embodiment, the substance deflector is flexible such as it may be deformed by the third conduit, introduction of which is allowed by the insert, but wherein the substance deflector cannot be deformed by the first conduit, introduction of which is blocked by the insert. Deformation of the substance deflector allows the third conduit to deliver a substance into the receiving conduit at a position further into the receiving conduit than the position of the substance deflector. The substance deflector thus does not deflect a substance from the third conduit.

In an embodiment, the insert includes retraction means for allowing alteration of the position of a blocking region of the insert within the receiving conduit when the insert is mounted within the receiving conduit. Preferably, the retraction means enables a change in length of the insert along its longitudinal axis. In some situations, it is desirable for the blocking region of the insert to have different longitudinal positions.

The retraction means preferably includes a mechanism for resiliently biasing the insert to its unretracted state. The retraction means may include a spring. By biasing the insert to its unretracted state, the presence of the insert is made clearer to the user.

In an embodiment, in its unretracted state, the blocking region protrudes from the reception aperture of the receiving conduit. This enables the blocking region to act as a visible reminder to the user.

Preferably, the mounting means enables the blocking region of the insert to be positioned substantially at the reception aperture of the receiving conduit. This is particularly advantageous where the insert does not include retraction means as any introduction at all of the first conduit into the second conduit will be prevented.

In an embodiment the mounting means enables the insert to be fitted substantially at the reception aperture of the receiving conduit.

The mounting means may comprise a sleeve corresponding to the reception aperture of the receiving conduit.

In an embodiment, the insert is for location within the neck of a vehicle fuel tank and the mounting means enables the insert to be fitted in place of a fuel cap. This provides a convenient mechanism for mounting the insert within the neck of a vehicle fuel tank without comprising the integrity of the vehicle fuel tank neck itself.

A substance channeling means for directing the flow of a substance from the third conduit through the receiving conduit is preferably provided. This acts to compensate for any obstruction to flow of the substance from the third conduit caused by the presence of the insert in the receiving conduit.

According to a second aspect of the present invention, there is provided a conduit assembly for preventing the introduction of a first conduit having a first size into the conduit assembly, the assembly including a second conduit having a reception aperture of a second size wherein the first size is smaller than the second size, and a blocking insert mounted within the second conduit, wherein the blocking insert physically blocks full introduction of the first conduit into the second conduit, but allows introduction of a third conduit having a third size into the conduit assembly, wherein the third size is smaller than the second size and is different from the first size.

In the preferred embodiment, the third size is greater than the first size.

In the preferred embodiment, the insert is positioned within the second conduit so as to prevent insertion of substantially any part of the first conduit into the conduit assembly. This is preferably achieved by an end of the insert extending substantially to the reception aperture of the second conduit. With this arrangement, the user will realise almost immediately that the selected conduit will not fit and is therefore incorrect.

According to a third aspect of the present invention, there is provided a vehicle fuel tank neck for blocking full introduction of an undesirable fuel pump nozzle having a first size into the vehicle fuel tank neck, the vehicle fuel tank neck having a fuel inlet port having an aperture of a second size, wherein the first size is smaller than the second size, and a blocking insert mounted to the fuel inlet port, wherein the blocking insert physically blocks full introduction of the undesirable fuel pump nozzle into the vehicle fuel tank neck, but allows introduction of a desirable fuel pump nozzle of a third size into the vehicle fuel tank neck, wherein the third size is smaller than the second size and is different from the first size.

This arrangement provides a simple and effective way of preventing insertion of an undesirable fuel pump nozzle into the fuel tank neck, whilst allowing insertion of a desirable fuel pump nozzle.

In the preferred embodiment, the third size is greater than the first size.

According to a fourth aspect of the present invention, there is provided a vehicle including a fuel tank neck for blocking full introduction of an undesirable fuel pump nozzle having a first size into the vehicle fuel tank neck, the vehicle fuel tank neck having a fuel inlet port having an aperture of a second size, wherein the first size is smaller than the second size, and a blocking insert mounted to the fuel inlet port, wherein the blocking insert physically blocks full introduction of the undesirable fuel pump nozzle into the vehicle fuel tank neck, but allows introduction of a desirable fuel pump nozzle having a third size into the vehicle fuel tank neck, wherein the third size is smaller than the second size and is different from the first size.

In the preferred embodiment, the third size is greater than the first size.

Preferred embodiments of the present invention are described below, by way of example only, with reference to the accompanying drawings, in which:

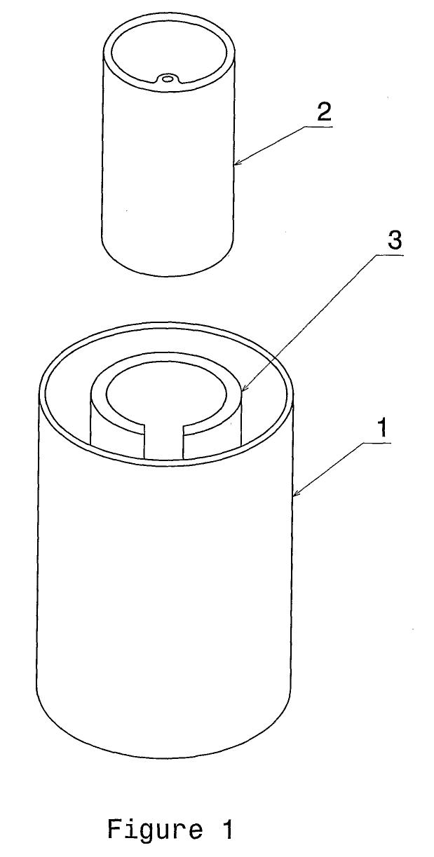

FIG. 1 is a schematic view of an insert in accordance with an embodiment of the present invention;

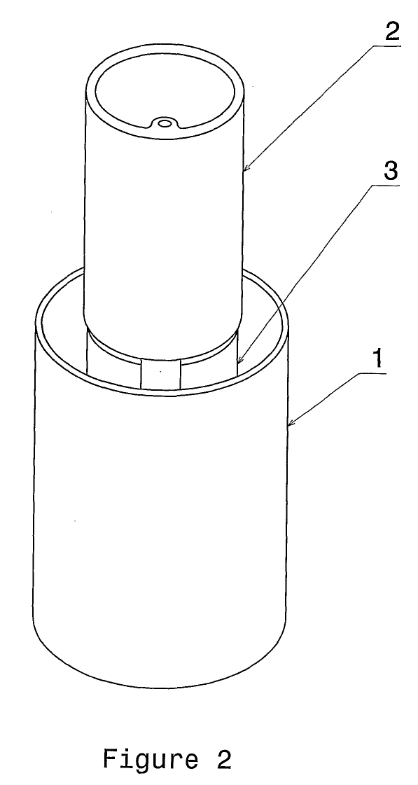

FIG. 2 is a schematic view of an insert in accordance with an embodiment of the present invention;

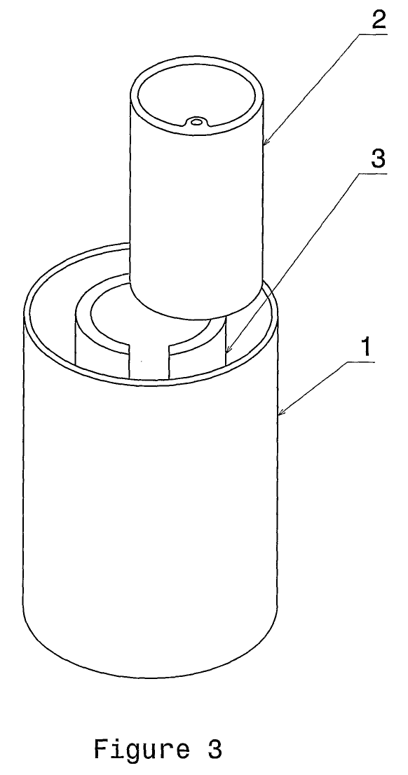

FIG. 3 is a schematic view of an insert in accordance with an embodiment of the present invention;

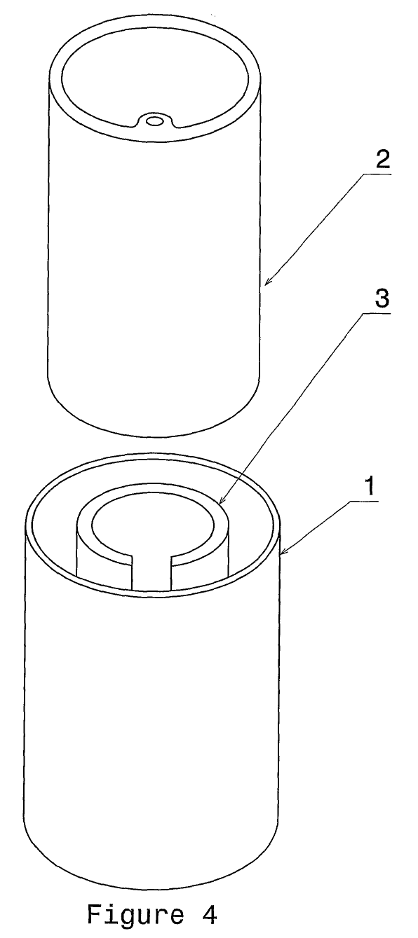

FIG. 4 is a schematic view of an insert in accordance with an embodiment of the present invention;

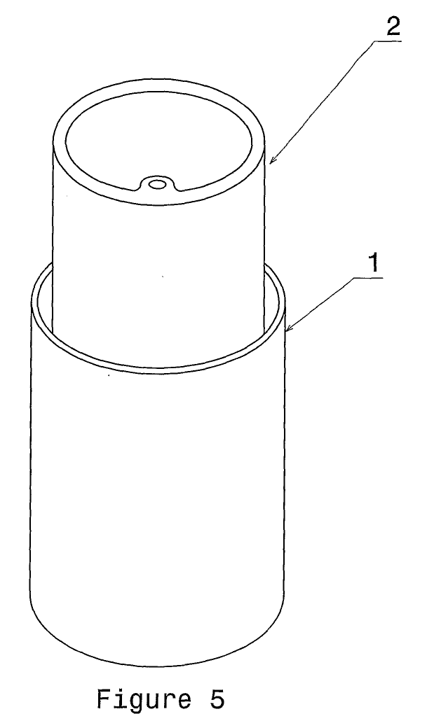

FIG. 5 is a schematic view of an insert in accordance with an embodiment of the present invention;

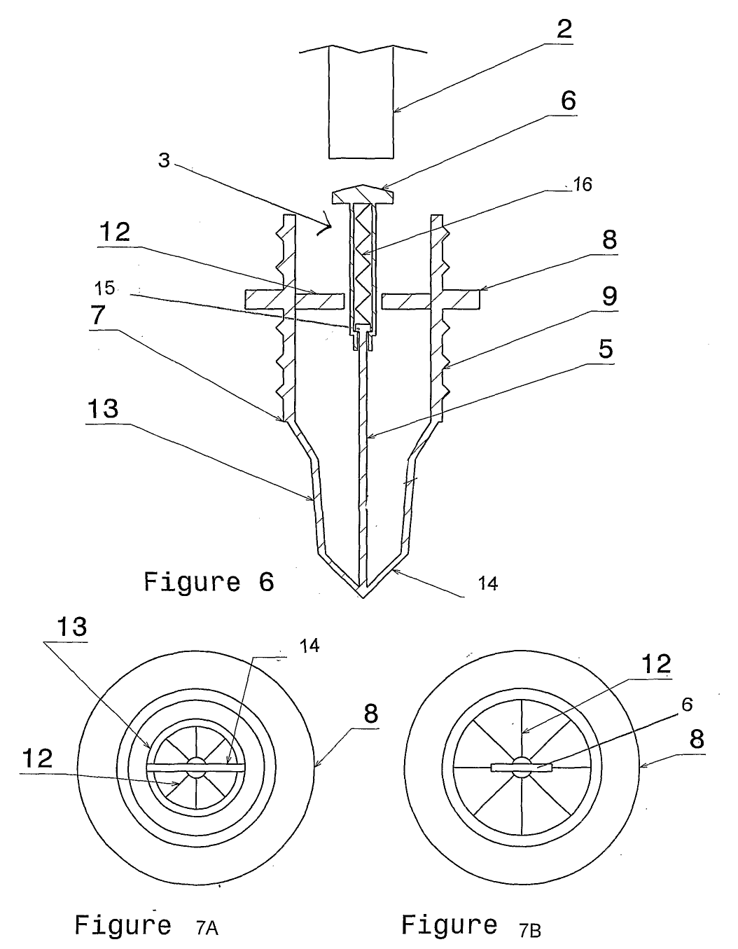

FIG. 6 is a view in section of a preferred embodiment of the present invention;

FIG. 7A is a top plan view of a preferred embodiment of the present invention;

FIG. 7B is a bottom plan view of a preferred embodiment of the present invention;

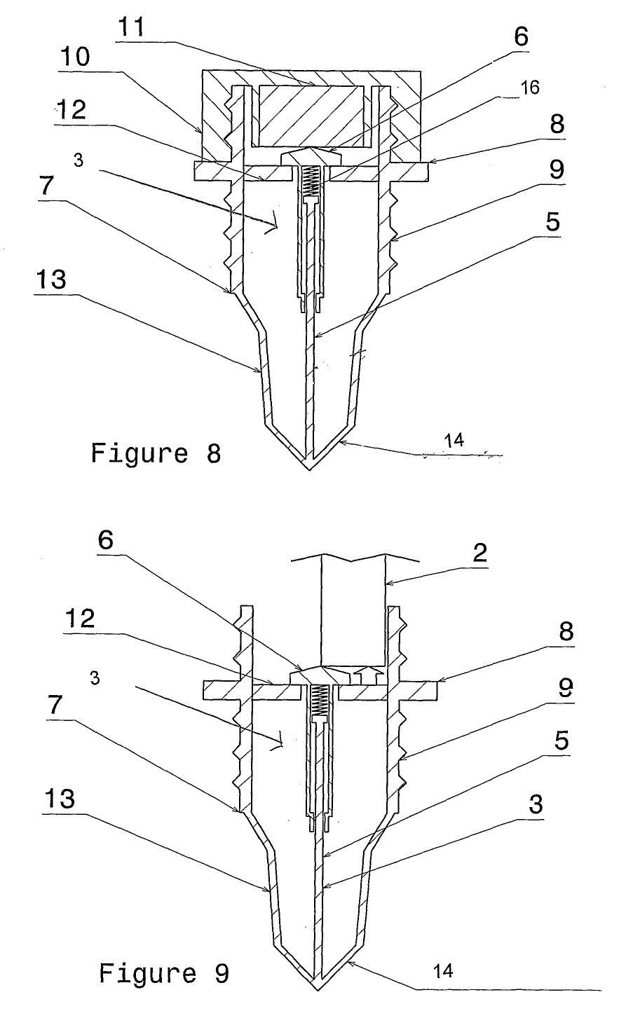

FIG. 8 is a view in section of a preferred embodiment of the present invention;

FIG. 9 is a view in section of a preferred embodiment of the present invention;

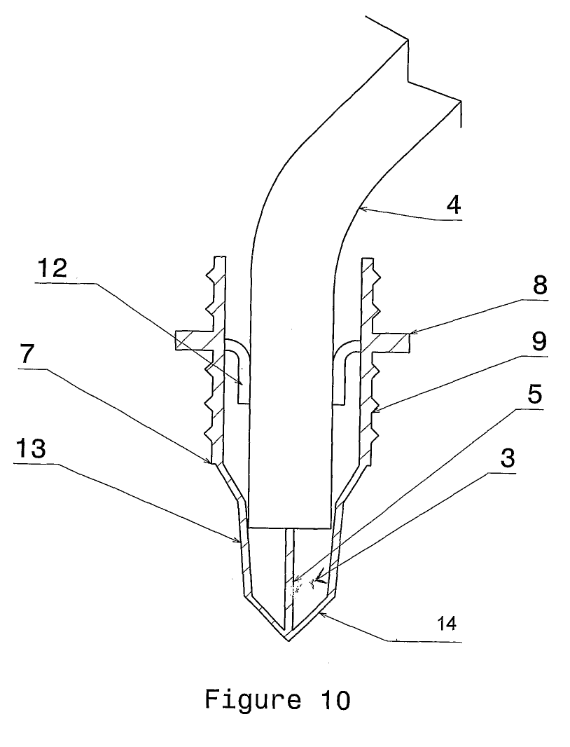

FIG. 10 is a view in section of a preferred embodiment of the present invention;

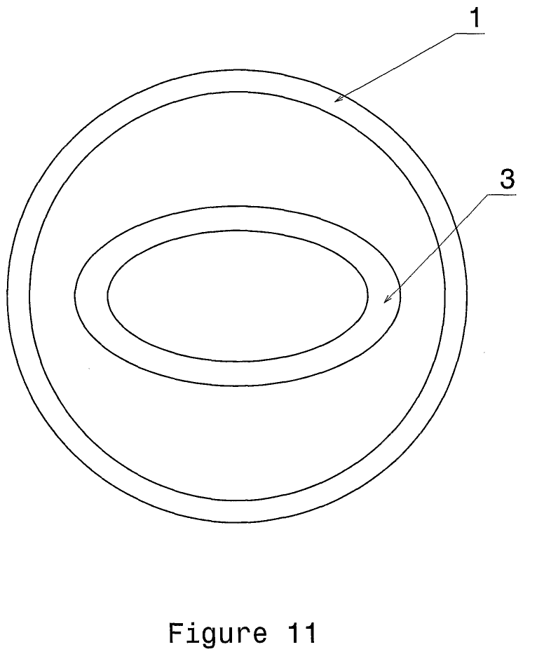

FIG. 11 is an end view of an insert in accordance with a further embodiment of the present invention;

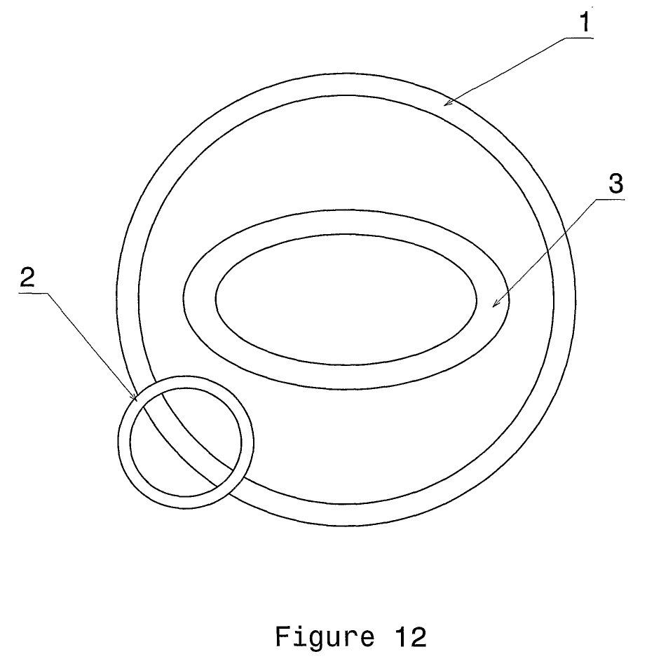

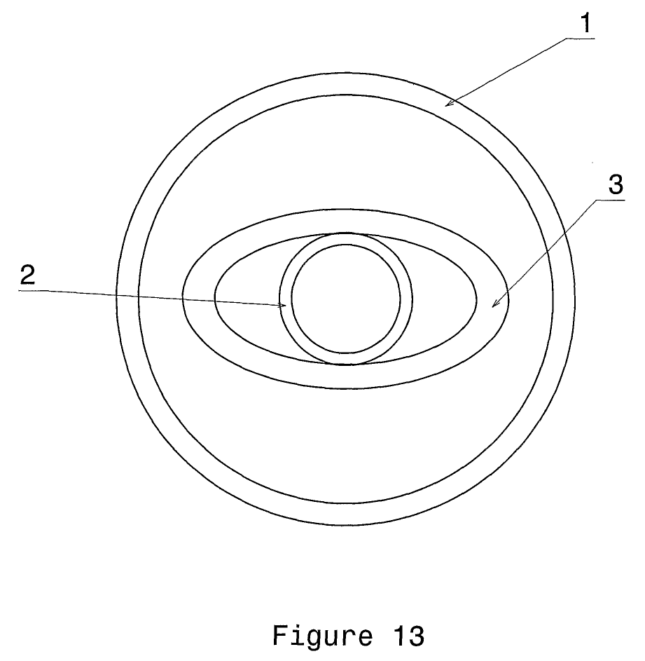

FIG. 12 is an end view of an insert in accordance with a further embodiment of the present invention;

FIG. 13 is an end view of an insert in accordance with a further embodiment of the present invention;

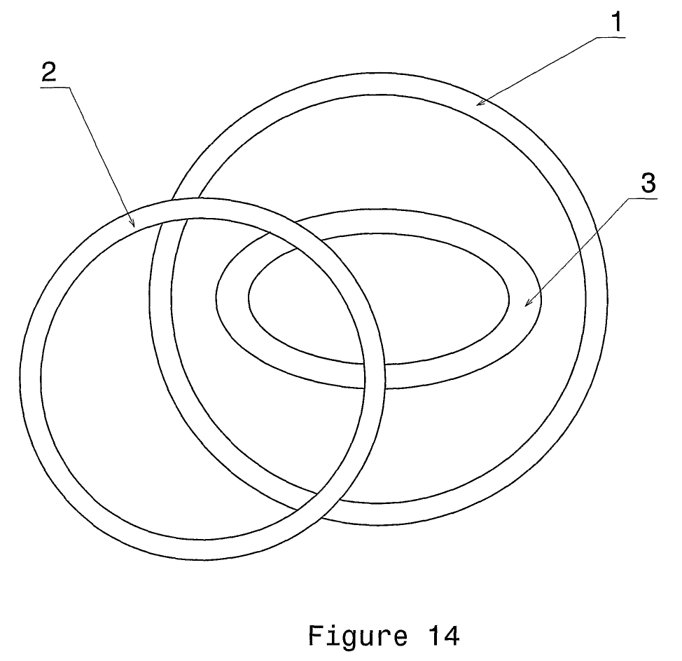

FIG. 14 is an end view of an insert in accordance with a further embodiment of the present invention;

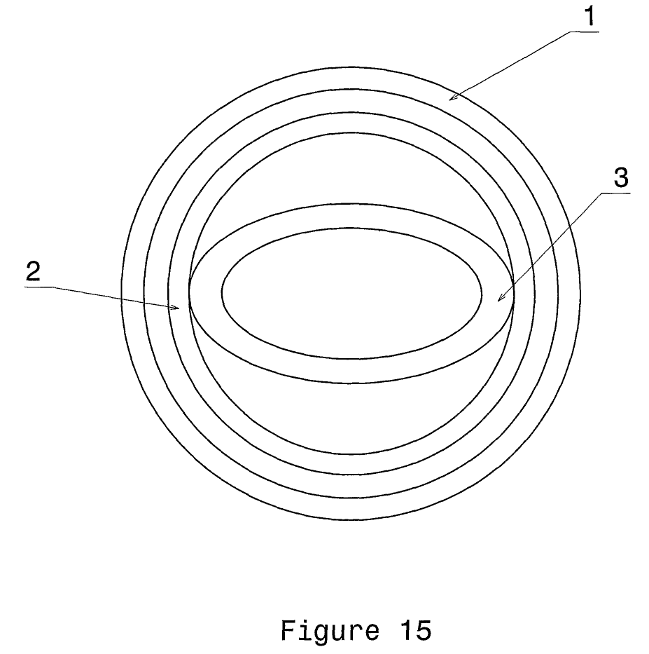

FIG. 15 is an end view of an insert in accordance with a further embodiment of the present invention;

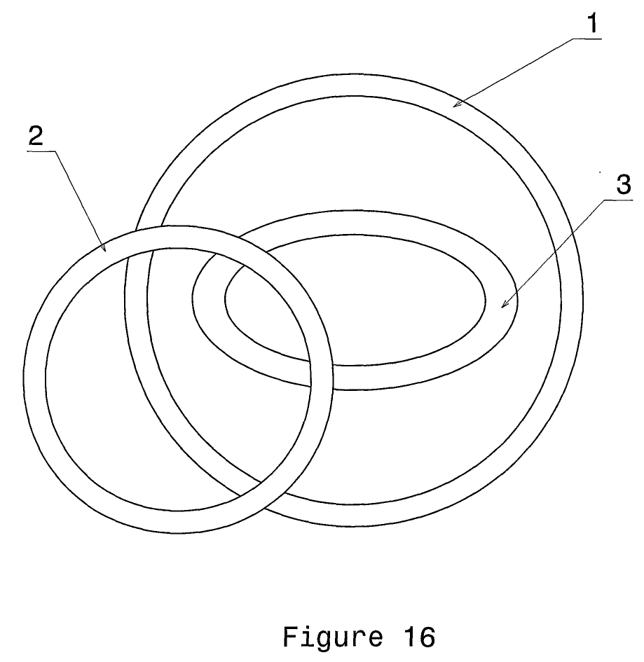

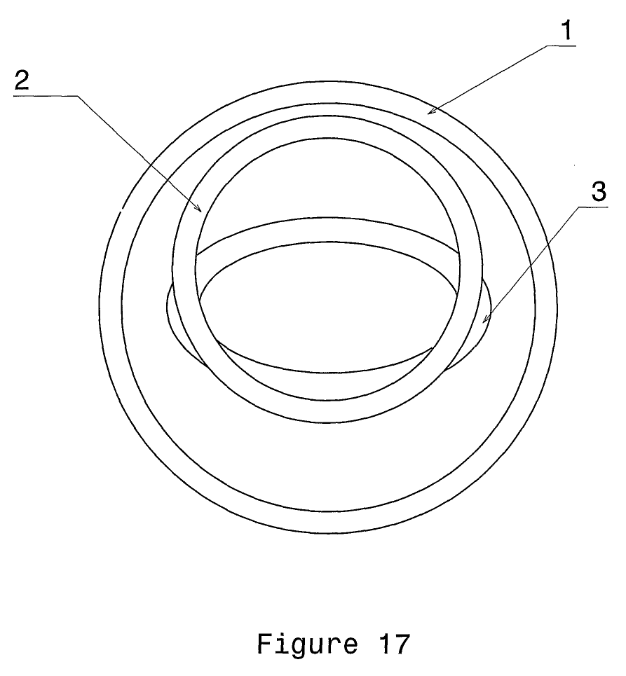

FIG. 16 is an end view of an insert in accordance with a further embodiment of the present invention;

FIG. 17 is an end view of an insert in accordance with a further embodiment of the present invention;

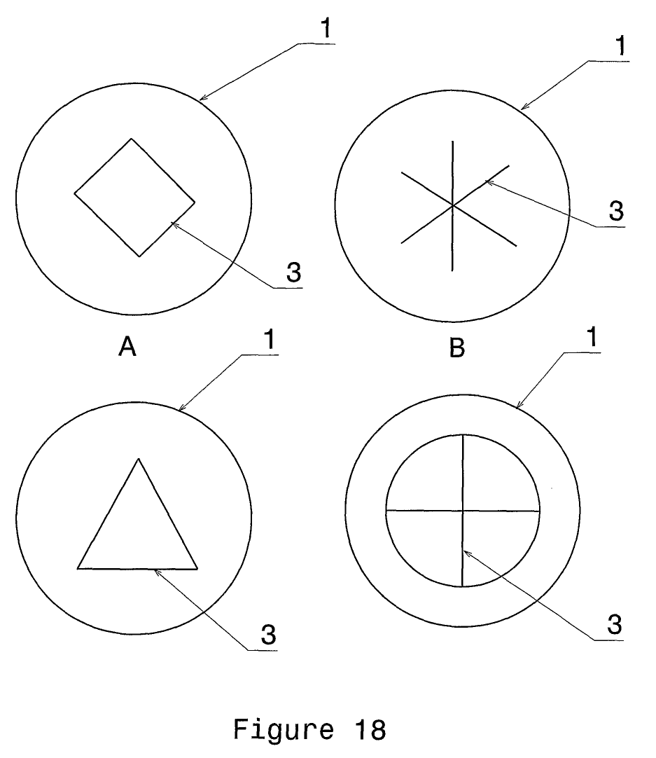

FIG. 18 shows end views of an insert in accordance with further embodiments of the present invention;

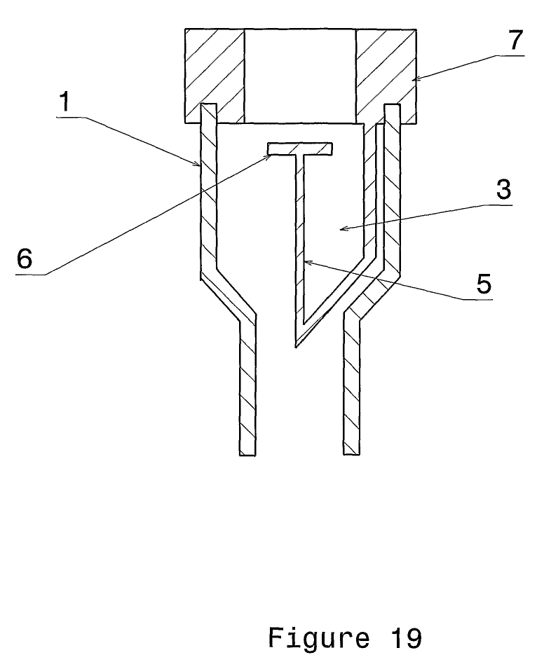

FIG. 19 is a view in section of another embodiment of the present invention; and

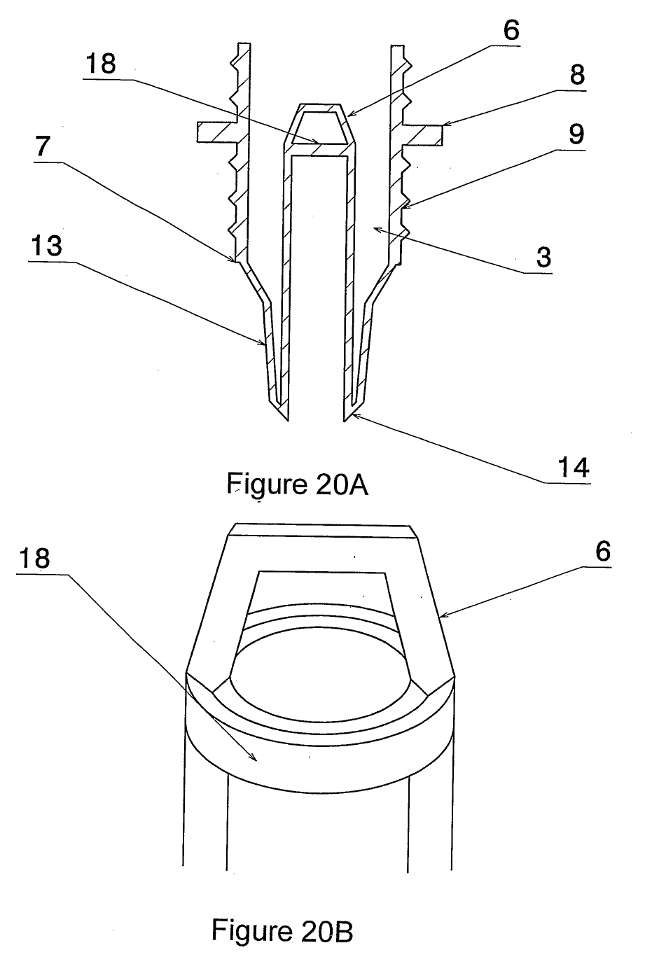

FIG. 20A is a view in section of another embodiment of the present invention; and

FIG. 20B is an enlarged perspective view of the embodiment shown in FIG. 20A.

The principle of using an insert to block entry of an unleaded petrol nozzle 2 into the neck of a diesel tank is illustrated in FIGS. 1 to 5. FIG. 1 shows the fuel inlet port 1 of a diesel tank neck, which connects the diesel tank neck to the car bodywork, and the nozzle 2 of an unleaded petrol pump. An insert 3 is mounted longitudinally (co-axially) within the diesel fuel inlet port 1. The insert 3 preferably has a diameter substantially the same as that of the petrol pump nozzle 2. The insert 3 is preferably mounted such that it is substantially concentric with the fuel inlet port 1 and the end of the insert 3 lies flush (or as close to flush as possible given any constraints imposed by the filler cap) with the end of the fuel inlet port 1.

As can be seen in FIGS. 2 and 3, the insert 3 prevents insertion of the petrol pump nozzle 2, both when a user attempts to insert it centrally, or if it is off-set from the centre. As the insert 3 has the same diameter as the petrol nozzle 2, the petrol nozzle 2 cannot fit inside the insert 3. This obstruction of the petrol nozzle 2 indicates to the user that they have not selected the correct fuel pump and helps to prevent them filling their diesel tank with petrol.

FIGS. 4 and 5 illustrate the situation where the user has selected the correct fuel (diesel) pump. The insert 3 has a smaller diameter than a diesel pump nozzle 4. The diesel pump nozzle 4 is thus able to fit over the insert 3 and thereby enable the user to fill the fuel tank with diesel. The diesel can flow into the tank both around and through the insert 3.

FIGS. 6 to 10 illustrate a preferred embodiment of an insert in accordance with the present invention, which is described in detail below.

A blocking insert 3 comprises a support portion 5 and a blocking portion 6. The blocking portion is sized so as to prevent an unleaded petrol nozzle 2 passing over the insert 3, thereby serving as an indication to the user that the unleaded petrol nozzle 2 should not be used to deliver fuel. As shown in FIG. 7B, the blocking portion 6 is preferably in the form of a narrow bar mounted on top of the support portion 5 such that the insert 3 has an overall T-shape. In the preferred embodiment, the blocking portion 6 has a length of 17½ mm and 19 mm (preferably 18½ mm, for example). This blocks an unleaded petrol nozzle 2 (as its internal bore size is smaller than the blocking portion 6), but allows passage of a diesel nozzle 4 (as its internal bore size is larger than the blocking portion 6). Of course some variation in the size of the blocking portion 6 is possible. The skilled person would appreciate how to design a suitably-sized blocking portion 6. Whilst the insert 3/blocking portion 6 can have many other different forms (see below) an advantage of the narrow bar of the preferred embodiment is that turbulence, back pressure and reflected flow are minimised.

The insert 3 allows the diesel pump nozzle 4 to be inserted adequately to allow filling (approximately 75 mm is the preferred length for this). The insert 3 is mounted to the mounting sleeve 7 by means of connecting bars 14 at the point furthest from the aperture to allow the required penetration by a diesel nozzle 4.

The device needs only limited physical strength because it need only indicate to the user that an incorrect pump has been selected. It does not need to be able to resist forceful insertion of an incorrect fuel pump nozzle 2. Permeability protection is not necessarily required; it can therefore be fabricated from any suitable material, including cheap polymers. Suitable materials include nylon, PPA, PVC, polypropylene and recycled forms thereof. Metal sections may be included.

The insert 3 is mounted substantially centrally within a mounting sleeve 7. The mounting sleeve includes a fixing ring 8 and threading 9, which together enable the mounting sleeve 7 to be fitted to the fuel inlet port of a diesel tank neck in place of a vehicle's usual fuel cap. Of course, the precise arrangement for fixing the mounting sleeve 7 to the fuel inlet port in place of a fuel cap depends on the fixing mechanism for the fuel cap on the particular make of vehicle.

Probably the insert 3 is mounted within the mounting sleeve 7 in such a way that the blocking portion 6 protrudes from the mounting sleeve 7 so that it is visible to the user. The support portion 5 of the insert 3 includes a telescopic portion comprising an internal spring 16 so that upon application of pressure to the blocking portion 6 the insert 3 is able to retract into the mounting sleeve 7. A stop 15 to limit travel of the retractable insert to a fully retracted position is also provided.

This retractability enables a fuel cap 10 including a pressure relief valve to be fitted to the mounting sleeve 7 in order to close the diesel tank neck once fuelling has been completed. The fuel cap 10 fitted to the mounting sleeve 7 is thus able to perform the same function as a standard fuel cap in providing both a seal to the tank to prevent leakage or spillage whilst allowing air to enter the tank to prevent a vacuum by means of the pressure relief valve 11. It can be seen that the mounting sleeve 7 effectively extends the fuel inlet port in order to allow a fuel cap 10 to be fitted to the mounting sleeve 7.

In the preferred embodiment, fuel reflection flaps 12 are provided. These are fabricated from a resilient material for example, an elastomeric polymer such as FKM. The fuel reflection flaps 12 substantially surround the blocking portion 6 of the insert 3. The fuel reflection flaps 12 are attached around the inside wall of the mounting sleeve 7, at a position further into the fuel inlet port than the blocking portion 6 of the insert 3 in its fully retracted position (see FIG. 9). The fuel reflection flaps 12 are able to deform when a diesel pump nozzle 4 is introduced into the mounting sleeve 7, but not when an unleaded petrol nozzle 2 is introduced into the mounting sleeve 7.

At the end of the mounting sleeve 7 to be positioned furthest within the fuel inlet port of the diesel tank neck, a funnel 13 is provided. The funnel has gradually tapering walls that terminate prior to meeting at a point. The funnel 13 directs fuel from a diesel nozzle 14 into the narrower part of a diesel tank neck. In other words it effectively extends the diesel tank neck up into the fuel inlet port. The funnel 13 preferably has a diameter of approximately 2.5 cm at its widest part, gradually tapering to a diameter of approximately 2 cm at its narrowest part. The taper may be at an angle of 5° for example. The funnel 13 serves to improve the laminar flow characteristics of the fuel as it leaves the diesel pump nozzle 4, thereby minimising turbulence.

In use, this device serves to assist a driver in ensuring that only a correct fuel nozzle (i.e. diesel pump nozzle 4) is used when refuelling a vehicle. Firstly, considering the situation where a driver selects an incorrect fuel nozzle (i.e. an unleaded petrol nozzle 2). The driver removes the fuel cap 10, thereby allowing the insert 3 to extend from its retracted position beyond the confines of the mounting sleeve 7 so that the presence of blocking portion 6 should not be missed by the driver. This acts as a first warning to cause the driver to check that he has selected the correct nozzle.

The driver attempts to insert an unleaded petrol nozzle 2 into the mounting sleeve 7. The size of the blocking portion 6 prevents the unleaded petrol nozzle 2 from passing over the insert 3. In order even to attempt to fuel the vehicle with unleaded petrol, the driver would have to push against the blocking portion 6 with the unleaded petrol nozzle 2 in order to cause the insert 3 to retract into the mounting sleeve 7. This should act as a second warning to the driver that an incorrect fuel nozzle has been selected.

Nevertheless, if the driver is determined to ignore these warnings, the fuel reflection flaps 12 act to avoid the incorrect fuel from entering the fuel tank. As best illustrated in FIG. 9, the driver has pushed the insert 3 into its fully retracted position and started fuelling with unleaded petrol. The driver is unable to force the fuel reflection flaps 12 open using the unleaded petrol nozzle 2 as the blocking portion 6 prevents access thereto. As indicated by the white arrow, fuel is reflected from the closed fuel reflection flaps 12 back towards the unleaded petrol nozzle 2. The unleaded petrol nozzle 2 detects the reflected fuel and shuts off the flow as if it had detected a full fuel tank.

In the case where the driver selects the correct fuel nozzle (i.e. diesel pump nozzle 4) as illustrated in FIG. 10, diesel fuel can be delivered. The diesel pump nozzle 4 passes over the blocking portion 6 of the insert 3. As access to the fuel reflection flaps 12 is not hindered, the user is able to deflect these with the diesel pump nozzle 4 in order fully to insert the diesel pump nozzle 4 and therefore to deliver diesel to the tank.

Furthermore, since the entry of the diesel nozzle 4 into the diesel tank neck proper may be hindered, the funnel 13 assists in directing a flow of diesel into the narrow part of a diesel fuel tank neck (see FIG. 10).

There are several advantages to the above-described embodiment.

The system proposed offers a real physical barrier to the inadvertent mis-filler. Whilst a small amount of unleaded petrol could still enter the diesel tank, an environment is created where the user would have to be extremely determined to bypass the system.

The above-described assembly capitalises on the development of the different diameters of petrol and diesel nozzles already implemented in order to help prevent a user filling a diesel car with petrol. It is low cost, has few moving parts and no electronics and can be fitted retrospectively into existing vehicles. The assembly fits to a vehicle and requires no modification or special action at the filling station.

It also has the benefit of simplicity. As indicated above, there are few moving parts, no electronics, no batteries; just a simple blocking device that will inform the user that there is a problem, whilst preventing the physical insertion of the unleaded filler.

The device can be easily fitted to existing vehicles, by means of fitting it in place of a standard fuel cap. Direct mounting to the internal part of a diesel tank neck and thus any resultant damage is thus avoided. Moreover, its design is independent of the geometry of the diesel tank neck.

Use of the device is independent of the geometry of the fuel filler neck, complexity per vehicle type is thus significantly reduced. The mechanism to install the device is simple and uses the same principle as the current cap, there is thus reduced risk of fuel leaks.

The narrow bar form of the blocking portion 6 and the presence of the funnel 13 independently serve to reduce turbulence, backpressure and reflected flow.

The ability of the blocking portion 6 to retract into the mounting sleeve 7 enables the blocking portion 6 to serve as a difficult to miss visible reminder to the user, whilst also allowing a fuel cap 10 to be fitted. The use of a retractable blocking device makes the whole process even more difficult to ignore, and actually may deflect the user from even attempting to mis-fuel. Moreover, as the blocking portion 6 is visible to the user during prior to insertion of a nozzle, it facilitates alignment of the diesel pump nozzle 4.

The blocking portion 6 allows a smaller conduit to pass between the blocking portion 6 and the sides of the fuel inlet port. An arrangement where passage of a smaller conduit through the insert 3 could be helpful in many circumstances. In some situations the desirable conduit may be smaller than the undesirable conduit 2. In the situation of blocking an unleaded petrol nozzle 2 from the neck of a diesel tank 1, an additive that perhaps improves performance or efficiency could be introduced via a smaller conduit.

The fuel reflection flaps 12 help to reduce the chance of fuel splash-back even when the (correct) diesel pump nozzle 4 has been selected. This improves cleanliness for the user. The fuel reflection flaps 12 also help to prevent bypassing of the blocking portion 6 by unleaded petrol from a partially inserted unleaded petrol nozzle 2.

It will not cause cut-out as a result of poor flow rate.

There are various modifications that may be made to the above-described embodiment.

In a simpler form, a non-retractable insert 3 can be located such that the blocking portion 6 does not extend beyond the mounting sleeve 7. The blocking portion 6 should be positioned such that a fuel cap can still be fitted. Whilst this may allow a few millimetres of penetration by the unleaded petrol nozzle 2, physical blocking of full insertion will still occur. Nevertheless, the end of the insert 3 should lie as close to the aperture of the mounting sleeve 7 as possible, thereby allowing only minimal insertion of the petrol pump nozzle 2.

In another modification the fuel cap 10 may be designed such that it does not take up so much space within the mounting sleeve 7. In such cases, a non-retractable insert 3 may be used with the blocking portion positioned substantially at the aperture of the mounting sleeve 7. In this version, whilst the blocking portion does not protrude from the mounting sleeve 7, it is still able to act as a clearly visible signal to the driver.

The retraction means could be of any suitable type. For example, instead of a spring 16, an expandable foam could be used. Other resilient means could be envisaged.

The fuel reflection flaps 12 are not an essential feature. Moreover, they need not be flexible. Non-deformable but movable fuel reflection flaps 12 may be envisaged. When fuel reflection flaps 12 are present the blocking portion 6 may be retractable or non-retractable.

Although it is preferred that the end of the insert 3 lie as close to the outer edge of the mounting sleeve 7 as possible, this is not necessary. As long as the user is provided with some indication that insertion of the petrol pump nozzle 2 is being blocked (for example, the user is unable fully to insert the petrol pump nozzle 2), the user will realise that the incorrect pump has been selected.

In another modification, an angled end is incorporated into the blocking portion 6, such that when an unleaded petrol nozzle 2 is pushed against it, it causes the unleaded petrol nozzle 2 to deflect sideways (or in any other chosen direction), away from the filling aperture. The insert 3 would also be less likely to retract under this partial lateral force.

The insert 3, may take forms other than as illustrated in the preferred embodiment. The insert 3 may, for example, comprise a hollow tube (see FIGS. 1 to 5). The insert may have a diameter substantially the same as that of the petrol pump nozzle 2. The insert 3 is mounted such that it is substantially concentric with the diesel tank neck 1 and the end of the insert 3 lies flush (or as close to flush as possible given any constraints imposed by the filler cap) with the end of the mounting sleeve 7. This is a simple design that forms an annular channel into which the diesel nozzle 4 can be inserted. An unleaded petrol nozzle 2 is blocked by the insert 3, but a conduit having a smaller diameter may pass through (rather than over) the tubular insert 3. The hollow tube design of the insert 3 helps to ensure that there is minimum obstruction to the flow of diesel.

Any form of insert 3 that is large enough to block the petrol pump nozzle 2, but that is small enough to allow the diesel pump nozzle 4 to pass over it is possible. There are a number of ways in which the same effect could be achieved, varying from the simple “T-bar” approach to a more complex arrangement of fins. In a modification the insert 3 could be an extended version of the blocking portion 6, such that it is in the form of an elongate cuboid having a length of approximately 75 mm, a width of approximately 17½ mm to 19 mm and a thickness of approximately 2 to 3 mm. In this version the blocking portion 6 is not distinguishable from the support portion 5.

The insert 3 need not be positioned substantially centrally. There simply needs to be enough space surrounding it for a diesel nozzle to pass around it, but not so much that a petrol nozzle could pass to the side of it.

In an embodiment of the invention, the insert 3 is designed such that it is able to prevent insertion of a range of sizes of undesirable nozzle 2. An exemplary way of achieving this is illustrated in FIGS. 11 to 18, where the insert 3 is elliptical in cross-section and hollow.

It can be seen from FIGS. 12 and 13 that the minimum size of nozzle 2 that would be prevented from being inserted into the fuel inlet port 1 has a diameter equal to the short axis of the ellipse. Any smaller and the nozzle 2 could be inserted through the elliptical insert 3.

From FIGS. 14 and 15, it can be seen that the maximum size of nozzle 2 that would be prevented from being inserted into the fuel inlet port 1 has a diameter equal to the long axis of the ellipse. Any larger and the nozzle 2 could be inserted around the elliptical insert 3 (in the same way as a desirable nozzle 4).

FIGS. 16 and 17 illustrate the situation where the nozzle 2 is of a size somewhere between the minimum and the maximum.

The same effect can be achieved with an insert having other designs. FIG. 18 shows some examples. FIGS. 18A and 18C show examples of inserts 3 where there is a minimum size of undesirable nozzle 2. In the examples of FIGS. 18B and 18D, there is no minimum size of undesirable nozzle 2.

The insert 3 could be of any suitable length. Indeed, if fitted with appropriate mounting means, it could be a simple solid disc, or an annular ring, having a length of, for example, approximately 1 cm or less. It need simply be strong enough not to break when a user tries to insert a petrol pump nozzle into the neck 1 of the diesel tank. Such an insert 3 would of course require a suitably displaced mounting means (for example, a relatively long support arm) that does not block insertion of a diesel nozzle 4. The skilled person would appreciate how to design suitable mounting means.

The insert 3 need not be solid along its length. It could be perforated to reduce potential hindrance to flow of diesel. The insert 3 could, for example, be formed of a mesh-like material.

As the device needs only limited physical strength and permeability protection may not be required it can be fabricated from any suitable material, including, for example, cheap polymers preferably cross-linked post-manufacture to improve hardness. Normal constraints on the use of polymers in fuel applications are largely related to the absorption of the fuel by (and therefore eventually permeability of) the polymer. As this device is fitted internally to the fuel tank it does not matter if there is a degree of absorption because the fuel remains within the fuel tank. Issues related to recycling and to life in service may also be taken into account when selecting a suitable material of manufacture.

It is possible to construct a single module specifically for any particular vehicle or cap system if preferred; in the case where a motor manufacturer wishes to install the item at source, for example. It would also be possible to ignore the vehicle's standard means of fitting a fuel cap completely and use an alternative common system such as a series of plastic fins running round the core piece rather like the plastic stopper in a bottle of sparkling wine.

The mounting sleeve 7 could be fitted in other ways, such as by use of a bayonet fitting. Of course, other fixing means for fixing the insert 3 to the vehicle may be envisaged, for example clips. The insert 3 may be mounted within the fuel inlet port 1 in any suitable manner that does not obstruct insertion of a diesel pump nozzle 4. The mounting means 7 should also allow free flow of diesel from an inserted diesel pump nozzle. The mounting means 7 could comprise a perforated disc, or a mesh. Even a single bracket of suitable strength could be used. The mounting means 7 may include fixing points or a pattern of fins that could either be an interference fit in the neck or physically attached or adhered to the tank or tank neck, for example. The insert 3 may be fixed to the inner surface of the fuel inlet port 1 by, for example, a plurality of radially spaced brackets (not shown). The brackets may be positioned at the end of the insert 3 that is to be fitted furthest into the body of a vehicle. In the preferred embodiment, a three-point fixing system would be used. The fixing system allows the desired diesel pump nozzle 4 to be inserted to the same extent as if the insert 3 were not present. The insert 3 may be fitted by brackets that do not obstruct the insertion of a diesel pump nozzle 4 at all. Therefore, the user will realise that he has selected an incorrect fuel pump nozzle 2 as long as there is any obstruction of insertion whatsoever.

There are a large number of different ways in which the insert could be fitted to an existing fuel inlet port 1, and an even greater number of ways in which it could be fitted in a new build environment. One method of fitting would be a tripod and glue system that sticks to the sides of the tank neck in three positions. An alternative would be a system fitted with a plastic cam that locks and in so doing forces three legs out laterally from the lower end of the device to fix the position of the insert. Another alternative would be for a number of fins to be fitted to the lower end of the device that effectively jam the device into position.

The insert need not be fitted retrospectively into a vehicle; it could be installed in new vehicles as they are manufactured. For example, the insert could be moulded with the fuel inlet port at the point of manufacture. Alternatively, a fuel inlet port or diesel tank neck containing the insert could be used to replace the existing structure in a diesel car.

Where the insert 3 is not mounted in place of a fuel cap, references to the blocking insert 6 being mounted at or extending beyond the aperture of the mounting sleeve 7 may be interpreted as referring to the fuel filling aperture.

FIG. 19 illustrates an alternative, simpler embodiment. In this embodiment, the mounting sleeve 7 is shortened such that it serves simply to mount the insert 3 to the fuel inlet port 1 in place of the standard fuel cap. The mounting sleeve 7 thus does not surround the insert 3 along its length. The form and location of the insert 3 are such that the blocking portion 6 does not extend beyond the mounting sleeve 7 and thus is positioned partially within the fuel inlet port 1. Its location allows a fuel cap to be fitted to the mounting sleeve 7. In use, the blocking portion 6 prevents full insertion of an unleaded petrol nozzle 2; a diesel pump nozzle 4 can pass over the blocking portion 6 of the insert 3, enabling the user to deliver diesel to the tank. An advantage of this embodiment is that the position of the blocking portion 6 is such that it extends further into an inserted diesel pump nozzle 4 and thus is less likely to cause turbulence that could lead to the sensor being tripped in the diesel pump nozzle 4 that stops fuel flow.

FIGS. 20A and 20B illustrate an alternative embodiment. In this embodiment, the insert 3 includes a blocking portion 6 that tapers gradually outwards. As in the above-described embodiments, a diesel nozzle 4 can pass over the entire insert 3 so as to engage with the upper interior part of the funnel 13. However, an unleaded petrol nozzle 2 is blocked by the blocking portion 6. The taper of the blocking portion 6 is designed so that an unleaded petrol nozzle 2 becomes lodged at a position just above a reflecting ring 18. The reflecting ring 18 functions in a similar manner to the fuel reflection flaps 12. Since the reflecting ring 18 is located just below the maximum entry point of an unleaded petrol nozzle 2, if a user (despite blocking of full insertion by the blocking portion 6) tried to deliver unleaded petrol, the fuel reflecting ring 18 reflects fuel back up towards the unleaded petrol nozzle 2 thereby triggering the fuel shut off. The fuel reflecting ring 18 thus preferably has a diameter substantially the same as the unleaded petrol nozzle 2. As can be seen in FIG. 20B, the reflecting ring 18 preferably has a circular channel in its upper surface to aid fuel reflection. Since a diesel nozzle 4 is able to bypass the reflecting ring, fuel shut off does not occur until the tank is full.

The skilled person will appreciate that modifications described with reference to the embodiment illustrated in FIGS. 6 to 10 can be applied to the embodiments illustrated in FIGS. 19 and 20 as appropriate.

The skilled person will appreciate that use of this device is not restricted to use in fuel tanks and pump nozzles. Any system in which it is desired to disallow full insertion of one conduit into another could utilise this system. The only thing that need change is the size of the insert, which should be appropriate to the conduits involved.

What the insert achieves is the prevention of insertion of nozzles of a particular size, a range of sizes, a number of specific sizes or a combination of the above. In the main embodiment the insert excludes a specific range of sizes (equivalent to a petrol nozzle) going into a diesel tank. However, the device can be configured to achieve, more than this. The device can preclude the insertion of a particular size but allow all others. The nozzles themselves may vary in shape and this concept can be used to ensure that nozzles can only be inserted at a predefined angle of orientation. This could be useful in fields other than car fuel.

The contents of United Kingdom patent applications GB 0602645.4 and GB 0615825.7, from which this application claims priority, and the contents of the accompanying Abstract are hereby incorporated by reference. The skilled person will appreciate that features described therein may be included in and/or combined with features of the present device as appropriate.

1-34. (canceled)

35. An insert for location within a fuel inlet port of a vehicle fuel neck, for blocking full introduction of a first conduit having a first size into the fuel inlet port, the fuel inlet port having a reception aperture of a second size, wherein the first size is smaller than the second size, the insert comprising mounting means for mounting the insert to the fuel inlet port, wherein when mounted to the fuel inlet port, the insert physically blocks full introduction of the first conduit into the fuel inlet port, but allows introduction of a third conduit having a third size into the fuel inlet port, the third size being smaller than the second size, and different from the first size.

36. An insert as claimed in claim 35, further comprising a substance-channelling means which includes a tapered portion, for directing the flow of a substance from the third conduit through the fuel inlet port.

37. An insert as claimed in claim 36, wherein the third size is greater than the first size.

38. An insert as claimed in claim 35 or claim 36, comprising a blocking region, for blocking full introduction of the first conduit into the fuel inlet port, and an access region, for allowing flow of a substance from the third conduit through or around the fuel inlet port.

39. An insert as claimed in claim 35 or claim 36, wherein the insert has an aperture through which a substance from the third conduit can flow.

40. An insert as claimed in claim 35 or claim 36, wherein the insert is substantially cylindrical.

41. An insert as claimed in claim 35 or claim 36, wherein in cross-section the insert is the same shape and size as the first conduit.

42. An insert as claimed in claim 35 or claim 36, wherein the insert is a hollow tube.

43. An insert as claimed in claim 35 or claim 36, wherein the insert includes a substance deflector for reducing a flow of a substance from the first conduit into the fuel inlet port.

44. An insert as claimed in claim 43, wherein the substance deflector substantially surrounds the insert.

45. An insert as claimed in claim 44, wherein the substance deflector is offset longitudinally from the blocking region of the insert, in a direction away from the reception aperture.

46. An insert as claimed in claim 45, wherein the substance deflector is movable to allow access therebeyond by the third conduit, introduction of which is allowed by the insert.

47. An insert as claimed in claim 45, wherein the substance deflector is flexible such that it may be deformed by the third conduit, introduction of which is allowed by the insert, but wherein the substance deflector cannot be deformed by the first conduit, introduction of which is blocked by the insert.

48. An insert as claimed in claim 35 or claim 36, wherein the insert includes retraction means for allowing alteration of the position of a blocking region of the insert within the fuel inlet port when the insert is mounted within the fuel inlet port.

49. An insert as claimed in claim 48, wherein the retraction means enables a change in length of the insert along its longitudinal axis.

50. An insert as claimed in claim 48, wherein the retraction means includes a mechanism for resiliently biasing the insert to its unretracted state.

51. An insert as claimed in claim 48, wherein in its unretracted state the blocking region protrudes from the reception aperture of the fuel inlet port.

52. An insert as claimed in claim 35 or claim 36, wherein mounting means enables the blocking region of the insert to be positioned substantially at the reception aperture of the fuel inlet port.

53. An insert as claimed in claim 52, wherein the mounting means comprises a sleeve engageable with the reception aperture of the fuel inlet port.

54. An insert as claimed in claim 35 or claim 36, wherein the mounting means enables the insert to be fitted in place of a fuel cap.

55. An insert as claimed in claim 36 wherein the substance channelling means facilitates flow of the substance into a narrower part of the fuel inlet port.

56. An insert as claimed in claim 36 wherein the substance channelling means is a hollow frustum through which the substance can flow.

57. A vehicle fuel tank neck having a fuel inlet port, and a blocking insert for blocking full introduction of an undesirable fuel pump nozzle having a first size into the vehicle fuel tank neck, the fuel inlet port having an aperture of a second size, and the first size being smaller than the second size, wherein the blocking insert physically blocks full introduction of the undesirable fuel pump nozzle into the vehicle fuel tank neck, but allows introduction of a desirable fuel pump nozzle having a third size into the vehicle fuel tank neck, the third size being smaller than the second size and different from the first size, the blocking insert including a substance channelling portion for directing the flow of a substance from the desirable fuel pump nozzle through the fuel inlet port.

58. A vehicle fuel tank neck as claimed in claim 57, wherein the third size is greater than the first size.

59. A vehicle including a vehicle fuel tank neck as claimed in claim 58 or claim 58.
